(19) United States
(12) Patent Application Publication
(10) Pub. No.: US 2023/0169593 A1
(43) Pub. Date: Jun. 1, 2023

(54) CREATING AND TRADING SYSTEM FOR TOKENIZED OPEN-END FUND AND METHOD THEREOF

(71) Applicant: MaiCapital Limited, Hong Kong (HK)

(72) Inventors: Siu Yue Michael Wong, Hong Kong (HK); Sze Man Benedict Ho, Hong Kong (HK)

(21) Appl. No.: 17/569,459

(22) Filed: Jan. 5, 2022

(30) Foreign Application Priority Data
Nov. 26, 2021 (CN) 202111423703.1

(51) Int. Cl. G06Q 40/06; G06Q 20/36

(52) U.S. Cl. CPC G06Q 40/06; G06Q 20/36

(57) ABSTRACT

A creating and trading system for tokenized open-end fund and a method thereof are disclosed. In the creating and trading system, a fund-end host deploys a smart contract corresponding to an open-end fund in a blockchain network, a performance fee is calculated and a token value is adjusted based on a ROI of an open-end fund, so that when a purchase request of a buyer's host is received, a token is generated based on the token value and the purchase request, and transmitted to a wallet address of the buyer's host, and a register of shareholders in the smart contract is updated; when a transfer request is received, a subscription function and a redemption function of the smart contract are executed to simulate a transfer transaction. Therefore, the fund-end host can centralize the process to avoid a transfer agent, to improve convenience, transparency and liquidity of fund transaction.

### BACKGROUND OF THE INVENTION

### 1. Field of the Invention

The present invention relates to an open-end fund system and a method thereof, and more particularly to a creating and trading system for tokenized open-end fund, and a method thereof.

### 2. Description of the Related Art

In recent years, with the popularization and vigorous development of blockchain, various blockchain-based applications have sprung up. Among the applications, the tokenization of real estate, stocks, fund or similar assets is one of the most popular applications.

Generally speaking, traditional assets, such as real estate, have very high entry conditions for investment and also have long closed periods, and lack a secondary market for investment. Therefore, in order to solve this situation, some manufacturers proposed a solution to convert the traditional assets into digitalized/tokenized securities (that is, security token); in this way, the assets can be divided into smaller investable units, and the investable units can be traded in established and regulated token exchanges. However, in an open-end fund, whenever investors enter the market, it should ensure that all investors are treated equally in paying performance fee, for example, when the return of investment (ROI) is high, the high performance fee should be paid; on the contrary, when the ROI is low, the low performance fee should be paid. If the token value is not dynamically adjusted and the performance fee is charged in a private or fixed proportion of internal deduction, which will reduce investors' willingness to buy and sell the open-end fund and cause the problem of poor fund transaction convenience, transparency and liquidity.

Therefore, what is needed is to develop an improved technical solution to solve the conventional technology problem of poor convenience, transparency and liquidity of fund transactions.

### SUMMARY OF THE INVENTION

An objective of the present invention is to provide a creating and trading system for tokenized open-end fund and a method thereof, so as to solve the conventional technology problem.

In order to achieve the objective, the present invention discloses a creating and trading system for tokenized open-end fund; the creating and trading system is applied on a blockchain network, and includes a fund-end host configured to connect and access the blockchain network, and the fund-end host includes a creating module, a calculation module, a subscription module and a transfer module. The creating module is configured to deploy a smart contract and a fund wallet address corresponding to an open-end fund in the blockchain network, wherein the smart contract comprises a register of shareholders, a subscription function, and a redemption function. The calculation module is connected to the creating module and configured to calculate an ROI of the open-end fund in a preset fixed period, and calculate a performance fee based on the ROI, and adjust a token value based on the performance fee. The subscription module is connected to the calculation module, wherein when the fund-end host receives a purchase request from a buyer's host, the subscription module executes the subscription function of the smart contract to generate N token based on the token value and first price information of the purchase request, to transfer the N token to a wallet address of the buyer's host from a fund wallet address, and store the number of the N token and the wallet address of the buyer's host in the register of shareholders, wherein N is a positive integer. The transfer module is connected to the calculation module, wherein when the fund-end host receives a transfer request comprising a source wallet address, a destination wallet address, and a transfer amount, the transfer module executes the subscription function and the redemption function of the smart contract, wherein when the subscription function is executed, M token corresponding to the transfer amount is generated and transferred to the destination wallet address, and the number of the M token and the destination wallet address are stored in the register of shareholders, and when redemption function is executed, the M token corresponding to the transfer amount is destroyed in the source wallet address, wherein M is a positive integer.

In order to achieve the objective, the present invention discloses a creating and trading method for tokenized open-end fund, and the creating and trading method is applied on a blockchain network and includes steps of: providing a fund-end host, wherein the fund-end host is permitted to connect and access the blockchain network; deploying a smart contract and a fund wallet address corresponding to an open-end fund in the blockchain network, by the fund-end host, wherein the smart contract comprises a register of shareholders, a subscription function, and a redemption function; calculating, by the fund-end host, a return-of-investment (ROI) of the open-end fund in a preset fixed period, and calculating a performance fee based on the ROI, and adjusting a token value based on the performance fee; when the fund-end host receives a purchase request from a buyer's host, executing the subscription function of the smart contract to generate N token based on the token value and first price information of the purchase request, to transfer the N token to the wallet address of the buyer's host from the fund wallet address, and store the number of the N token and the wallet address of the buyer's host in the register of shareholders, wherein N is a positive integer; when the fund-end host receives a transfer request comprising a source wallet address, a destination wallet address and a transfer amount, executing the subscription function and the redemption function of the smart contract, wherein when the subscription function is executed, M token corresponding to the transfer amount is generated and transferred to the destination wallet address, the number of the M token and the destination wallet address are stored in the register of shareholders, and when the redemption function is executed, the M token is destroyed in the source wallet address, wherein M is a positive integer.

According to the above-mentioned system and method of the present invention, the difference between the present invention and the conventional technology is that, in the creating and trading system of the present invention, the fund-end host deploys the smart contract corresponding to the open-end fund in the blockchain network, the performance fee can be calculated and the token value can be adjusted based on the ROI of the open-end fund, so that when the purchase request of the buyer's host is received, the token is generated based on the token value and the purchase request, and transmitted to the wallet address of the buyer's host, and the register of shareholders in the smart contract is updated; when the transfer request is received, the subscription function and the redemption function of the smart contract are executed to simulate the transfer transaction. Therefore, the fund-end host can centralize the process to avoid a transfer agent.

According to the above-mentioned solution, the present invention is able to achieve the technical effect of improving convenience, transparency and liquidity of fund transaction.

### BRIEF DESCRIPTION OF THE DRAWINGS

The structure, operating principle and effects of the present invention will be described in detail by way of various embodiments which are illustrated in the accompanying drawings.

FIG. 1A is a system block diagram of a creating and trading system for tokenized open-end fund, according to the present invention.

FIG. 1B is another system block diagram of a creating and trading system for tokenized open-end fund, according to the present invention.

FIGS. 2A and 2B are a flowchart of a creating and trading method for tokenized open-end fund, according to the present invention.

FIG. 2C is an another flowchart of a creating and trading method for tokenized open-end fund, according to the present invention.

FIG. 3 is a schematic view of a register of shareholders, according to the present invention.

FIG. 4 is a schematic view of an operation of subscribing, transferring and redeeming an open-end fund, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The application environment of the present invention is illustrated before descriptions of the creating and trading system for tokenized open-end fund and a method of the present invention. The present invention is applied to blockchain network environment, and deploy a smart contract corresponding to open-end fund in the blockchain network environment. The smart contract means a computer program for driving execution commands based on a predetermined condition and transferred information, and particularly, the smart contract is programmed with programming language, such as Solidity, Serpent, LLL, EtherScript, or Sidechain, and the smart contract can include different functions, events and parameter states; for example, the smart contract can include a subscription function and a redemption function.

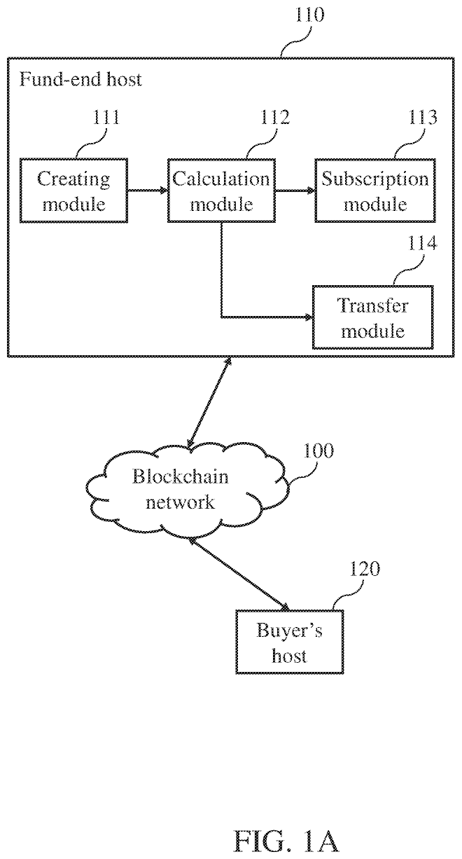

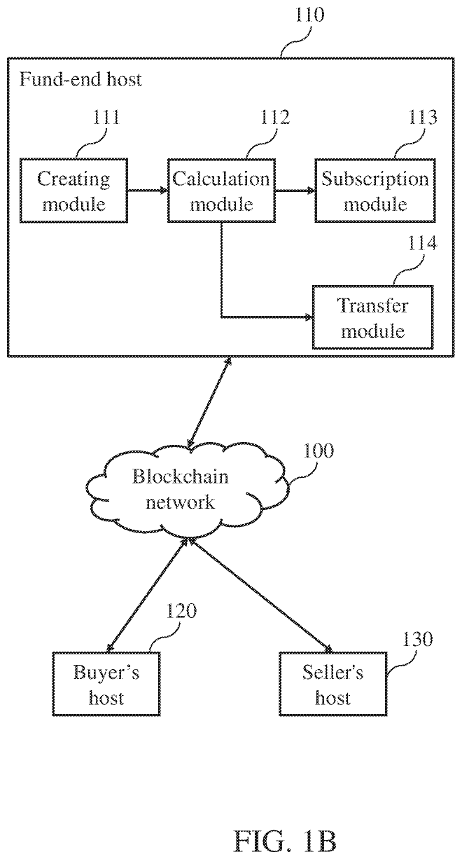

The creating and trading system for tokenized open-end fund and a method of the present invention will hereinafter be described in more detail with reference to the accompanying drawings. Please refer to FIG. 1A, which is a system block diagram of a creating and trading system for tokenized open-end fund, according to the present invention. The system is applied on a blockchain network 100, and includes a fund-end host 110 configured to connect and access the blockchain network 100. The fund-end host 110 includes a creating module 111, a calculation module 112, a subscription module 113 and a transfer module 114. The creating module 111 is configured to deploy a smart contract and a fund wallet address corresponding to an open-end fund in the blockchain network 100. The smart contract can include a register of shareholders, a subscription function and a redemption function. In actual implementation, data of the register of shareholders can be stored in a variable array declared by the smart contract, the register of shareholders can include shareholder metadata and a shareholder wallet address corresponding to the shareholder metadata; when the smart contract is executed, the smart contract is permitted to create, read, update or delete the shareholder metadata and the shareholder wallet address corresponding to the shareholder metadata.

The calculation module 112 is connected to the creating module 111, and configured to calculate an ROI of the open-end fund in a preset fixed period, and calculate a performance fee based on the ROI, so as to adjust a token value based on the performance fee. In actual implementation, the fixed time period can be, for example, one year, three years, five years, or any assigned period; and the ROI of the open-end fund within the period can be calculated, for example, the ROI can be 18%, so that the performance fee that should be paid to the fund manager or fund company can be calculated. Next, the token value can be adjusted based on the performance fee, for example, when the performance fee is high, the token value is decreased, because when the fee paid to the fund manager or the fund company rises under the condition that the price of each equity unit of the fund does not change, it indicates that the value of each token becomes lower; in contrast, when the performance fee is low, the token value is increased. Furthermore, under the condition that the price of each equity unit of the fund is changeable, a high performance fee indicates a good ROI, that is, the price of each equity unit rise, so the token value is increased; in contrast, a low performance fee indicates a bad ROI, so the token value is decreased.

The subscription module 113 is connected to the calculation module 112, and when the fund-end host 110 receives a purchase request from a buyer's host 120, the subscription module 113 executes the subscription function of the smart contract, to generate N token based on the token value and first price information of the purchase request, and transfer the N token from the fund wallet address to the wallet address of the buyer's host 120, and store the number of the N token and the wallet address of the buyer's host 120 to the register of shareholders, wherein N is a positive integer. In other words, the token is not generated by executing the subscription function until the subscription is submitted, and a buyer profile and the amount of held token are stored as the shareholder metadata, the wallet address of the buyer's host is stored as the wallet address of the shareholder. In actual implementation, when the fund-end host 110 generates the tokens, the number of the generated tokens and transaction party information are stored into the register of shareholders as one of at least one piece of the shareholder metadata, the wallet address of the buyer's host 120 or the destination wallet address is stored as the shareholder wallet address corresponding to the shareholder metadata, and the generated tokens are transferred from the fund wallet address to the corresponding shareholder wallet address; that is, the tokens generated by executing the subscription function are stored in the fund wallet address and transferred to the corresponding shareholder wallet address, and the token owner information (such as transaction party information) and the wallet address recorded in the register of shareholders are updated.

The transfer module 114 is connected to the calculation module 112, and when the fund-end host 110 receives the transfer request including a source wallet address, a destination wallet address and a transfer amount, the subscription function and the redemption function of the smart contract are executed at the same time; when the subscription function is executed, M token corresponding to the transfer amount is generated and transferred to the destination wallet address, and the number of the M token and the destination wallet address are stored in the register of shareholders; when the redemption function is executed, the M token in the source wallet address is destroyed, and M is a positive integer. In actual implementation, compared to the conventional method of directly transferring the token from the seller to the buyer, when the token generated in the present invention is to transferred, the transfer module 114 executes the subscription function and the redemption function to simulate the transaction and token transfer between the buyer and the seller. In this way, some problems such as lack of transfer agent can be overcome. In addition, the manner of destroying the tokens is to transfer the tokens to an eater address, or execute the destroy function of the smart contract to destroy the tokens.

Please refer to FIG. 1B, which is another system block diagram of a creating and trading system for a tokenized open-end fund, according to the present invention. As shown in FIG. 1B, the system is applied on a blockchain network 100, and includes a fund-end host 110 configured to connect and access the blockchain network 100. Compared to the embodiment of FIG. 1A, the embodiment of FIG. 1B additionally includes a seller's host 130, and when the fund-end host 110 receives the sell request from the seller's host 130 and the purchase request of the buyer's host 120 also exists in the fund-end host 110, the fund-end host 110 compares second price information of the sell request and the first price information of the purchase request, when the first price information matches the second price information, the subscription function and the redemption function are executed to destroy the token equivalent to the second price information in the wallet address of the buyer's host 120, and transfer the token equivalent to the second price information from the fund wallet address to a wallet address of the seller's host 130, and update the shareholder metadata corresponding to the buyer's host 120 and the seller's host 130 and the shareholder wallet address corresponding to the shareholder metadata in the register of shareholders. For example, in a condition that the first price information is set as a value of 50, the second price information is also set as a value of 50, so the first price information and the second price information are regarded as matching with each other. In this case, after the token equivalent to the second price information 50 is destroyed in the wallet address of the buyer's host 120 and the token equivalent to the second price information “50” is generated, the generated token is transferred from the fund wallet address to the wallet address of the seller's host 130.

It is to be particularly noted that, in actual implementation, the modules of the present invention can be implemented by various manners, including software, hardware or any combination thereof, for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

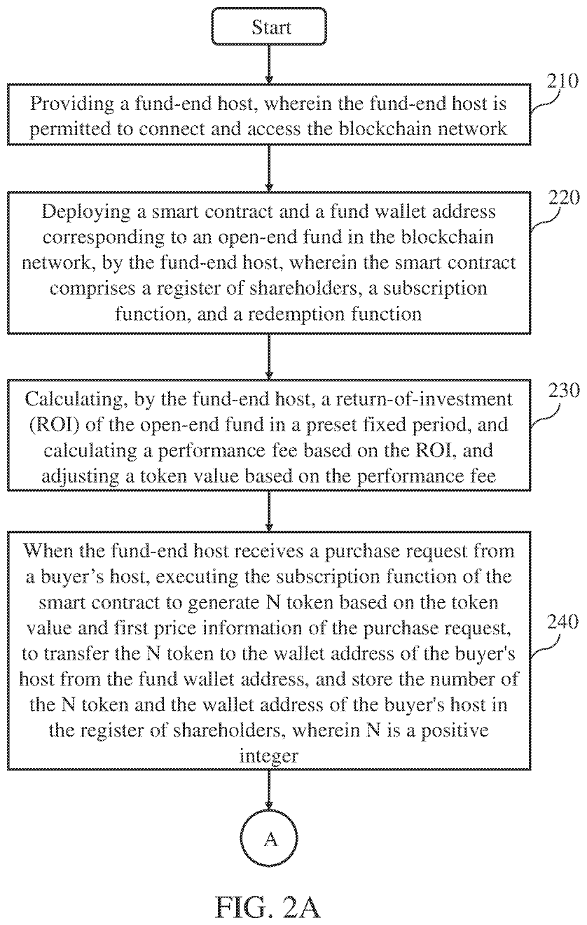

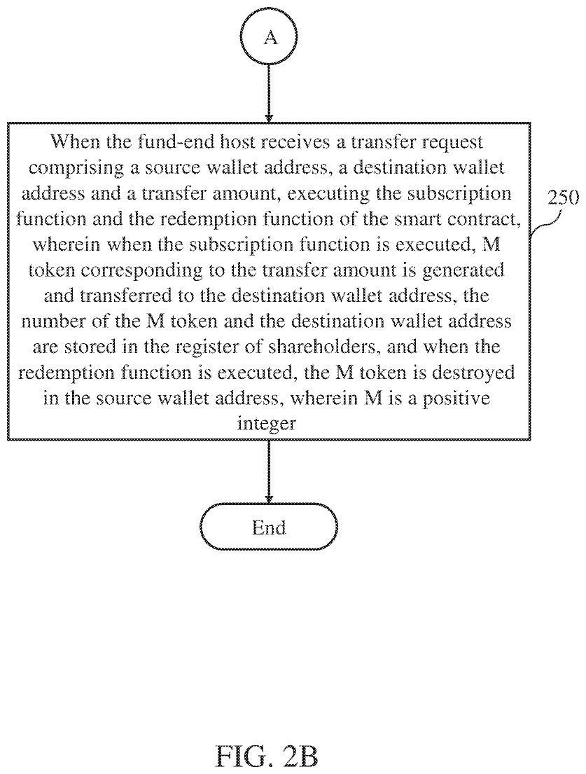

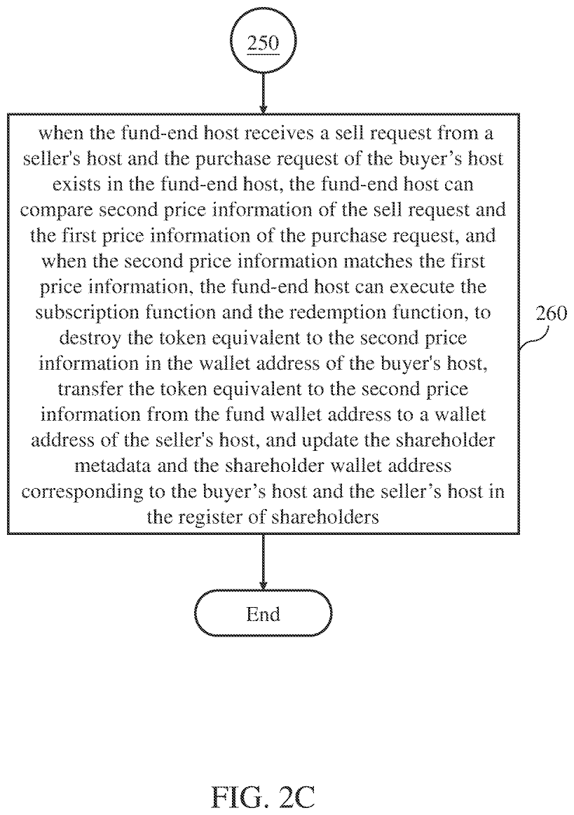

Please refer to FIGS. 2A and 2B, which are a flowchart of a creating and trading method for tokenized open-end fund, according to the present invention. As shown in FIGS. 2A and 2B, the creating and trading method includes steps 210-250. In a step 210, a fund-end host 110 is provided, and the fund-end host 110 is permitted to connect and access the blockchain network 100. In a step 220, the fund-end host 110 deploys a smart contract and a fund wallet address corresponding to an open-end fund in the blockchain network 100, wherein the smart contract comprises a register of shareholders, a subscription function, and a redemption function. In a step 230, the fund-end host 110 calculates a return-of-investment (ROI) of the open-end fund in a preset fixed period, and calculates a performance fee based on the ROI, and adjusts a token value based on the performance fee. In a step 240, when the fund-end host 110 receives a purchase request from a buyer's host 120, the fund-end host 110 executes the subscription function of the smart contract to generate N token based on the token value and first price information of the purchase request, and transfers the N token to the wallet address of the buyer's host 120 from the fund wallet address, and stores the number of the N token and the wallet address of the buyer's host 120 in the register of shareholders, wherein N is a positive integer. In a step 250, when the fund-end host 110 receives a transfer request comprising a source wallet address, a destination wallet address and a transfer amount, the fund-end host 110 executes the subscription function and the redemption function of the smart contract, wherein when the subscription function is executed, M token corresponding to the transfer amount is generated and transferred to the destination wallet address, the number of the M token and the destination wallet address are stored in the register of shareholders, and when the redemption function is executed, the M token is destroyed in the source wallet address, wherein M is a positive integer. Through aforementioned steps, the fund-end host 110 can deploy the smart contract corresponding to the open-end fund in the blockchain network 100, the performance fee can be calculated and the token value can be adjusted based on the ROI of the open-end fund, so that when the purchase request of the buyer's host 120 is received, the token can be generated based on the token value and the purchase request, and transmitted to the wallet address of the buyer's host 120, and the register of shareholders in the smart contract is also updated; when the transfer request is received, the subscription function and the redemption function of the smart contract are executed to simulate the transfer transaction. Therefore, the fund-end host 110 can centralize the process to avoid a transfer agent.

Please refer to FIG. 2C, which is an another flowchart of a creating and trading method for tokenized open-end fund, according to the present invention. The difference between FIG. 2C and FIGS. 2A-2B is that the embodiment shown in FIG. 2C includes a step 260 after the step 250. As shown in FIG. 2C, in the step 260, when the fund-end host 110 receives a sell request from a seller's host 130 and the purchase request of the buyer's host 120 exists in the fund-end host 110, the fund-end host 110 can compare second price information of the sell request and the first price information of the purchase request, and when the second price information matches the first price information, the fund-end host 110 can execute the subscription function and the redemption function, to destroy the token equivalent to the second price information in the wallet address of the buyer's host 120, transfer the token equivalent to the second price information from the fund wallet address to a wallet address of the seller's host 130, and update the shareholder metadata and the shareholder wallet address corresponding to the buyer's host 120 and the seller's host 130 in the register of shareholders.

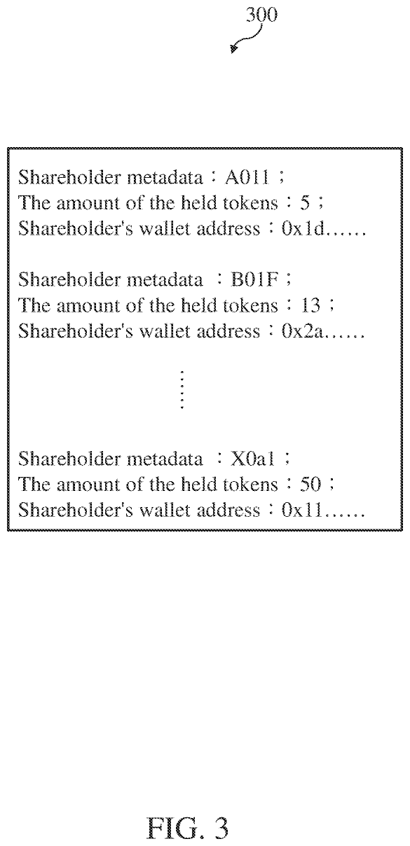

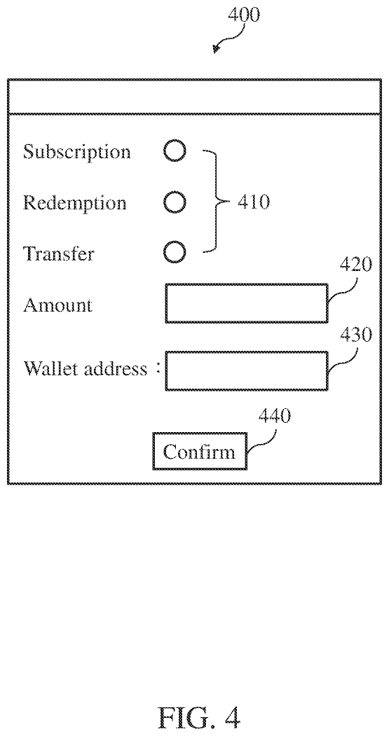

The operation of the present invention will be illustrated according to embodiment with reference to FIG. 3 and FIG. 4. Please refer to FIG. 3, which is a schematic view of a register of shareholders, according to the present invention. In actual implementation, the register of shareholders 300 can include shareholder metadata and a shareholder wallet address corresponding to the shareholder metadata. The shareholder metadata can include shareholder's personal information, identify information, or other unique information (such as unique identifier, ID number, or resident certificate number); the shareholder metadata also includes the amount of the tokens of the open-end fund held by the shareholder. The shareholder wallet address can be a shareholder's wallet address configured to identify where the token owner stores the token. The shareholder is the person holding the tokens of the open-end fund. When the smart contract is executed to subscribe, redeem or transfer token, the smart contract is permitted to create, read, update or delete the shareholder metadata and the shareholder wallet address corresponding to the shareholder metadata; for example, the smart contract can create data for new subscription, update data for partial sell/redemption, or delete data for fully sell/redemption. In this way, the register of shareholders can be read to clearly obtain the owner (shareholder) information of the open-end fund and the amount of the fund shares (such as the amount of the tokens) held by the shareholder, so that it is convenient for auditing and checking.

Please refer to FIG. 4, which is a schematic view of an operation of subscribing, transferring and redeeming an open-end fund, according to the present invention. When the buyer wants to subscribe the open-end fund, the buyer can open a transaction window 400 through the buyer's host 120, and select the “subscription” item in the selection component 410; next, the buyer can input a transaction price in a number input block 420, and then click a determination component 440 after inputting a wallet address in the address input block 430, so as to trigger the buyer's host 120 to generate a purchase request according to the selection, the inputted price and the wallet address; the input price is used as the first price information. Next, the buyer's host 120 transmits the generated purchase request to the fund-end host 110, the fund-end host 110 executes the subscription function of the smart contract to generate the corresponding amount of tokens based on the token value and the first price information of the purchase request. For example, in a condition that the token value is five US per unit, the first price information is 50 US, 10 tokens are generated and transferred from the fund wallet address to the wallet address of the buyer's host 120, and the number of 10 and the wallet address of the buyer's host 120 are stored in the register of shareholders. In order to transfer the held open-end fund, the user can select a “transfer” item in the selection component 410 of the transaction window 400, and input the amount (such as 10) of the tokens to be transferred in the number input block 420, and then input the wallet address of the transfer destination in the address input block 430, and click the determination component 440. In this case, the buyer's host 120 generates the transfer request according to aforementioned selection, and the inputted amount and the wallet address; the inputted amount is used as the transfer amount, the inputted wallet address is used as the destination wallet address, and the wallet address of the buyer's host 120 is used as the source wallet address. Next, the buyer's host 120 transmits the generated transfer request to the fund-end host 110, the fund-end host 110 executes the subscription function and the redemption function of the smart contract; when the subscription function is executed, 10 tokens are generated and transferred to the destination wallet address, and the number of 10 and the destination wallet address are recorded in the register of shareholders; when the redemption function is executed, the 10 tokens corresponding to the transfer amount in the source wallet address are destroyed. In this way, the subscription and redemption can be executed to implement the token transfer, so as to overcome the problem of failure of transfer due to lack of transfer agent. In addition, in order to sell/redeem the open-end fund, a user can select “redeem” item in the selection component 410, input the sell price (that is, the second price information) in the number input block 420, and then input the wallet address of the held token in the address output block. When the fund-end host 110 receives the sell request from the seller's host 130 and the purchase request of the buyer's host 120 also exists in the fund-end host 110, the fund-end host 110 can compare second price information of the sell request and the first price information of the purchase request, and when the first price information matches the second price information, the fund-end host 110 executes the subscription function and the redemption function, to destroy the tokens equivalent to the second price information in the wallet address of the buyer's host 120, and transfer the tokens equivalent to the second price information from the fund wallet address to the wallet address of the seller's host 130, and update the shareholder metadata corresponding to the seller's host 130 and the shareholder wallet address corresponding to the shareholder metadata in the register of shareholders.

Therefore, the difference between the present invention and the conventional technology is that, in the creating and trading system of the present invention, the fund-end host deploys the smart contract corresponding to the open-end fund in the blockchain network, the performance fee can be calculated and the token value can be adjusted based on the ROI of the open-end fund, so that when the purchase request of the buyer's host is received, the token is generated based on the token value and the purchase request, and transmitted to the wallet address of the buyer's host, and the register of shareholders in the smart contract is updated; when the transfer request is received, the subscription function and the redemption function of the smart contract are executed to simulate the transfer transaction. Therefore, the fund-end host can centralize the process to avoid a transfer agent. According to the above-mentioned solution, the present invention is able to achieve the technical effect of improving convenience, transparency and liquidity of fund transaction.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A creating and trading system for tokenized open-end fund, applied on a blockchain network, and the creating and trading system comprising:
a fund-end host, configured to connect and access the blockchain network, wherein the fund-end host comprises:
a creating module, configured to deploy a smart contract and a fund wallet address corresponding to an open-end fund in the blockchain network, wherein the smart contract comprises a register of shareholders, a subscription function, and a redemption function;
a calculation module, connected to the creating module and configured to calculate an ROI of the open-end fund in a preset fixed period, and calculate a performance fee based on the ROI, and adjust a token value based on the performance fee;
a subscription module, connected to the calculation module, wherein when the fund-end host receives a purchase request from a buyer's host, the subscription module executes the subscription function of the smart contract to generate N token based on the token value and first price information of the purchase request, to transfer the N token to a wallet address of the buyer's host from a fund wallet address, and store the number of the N token and the wallet address of the buyer's host in the register of shareholders, wherein N is a positive integer; and
a transfer module, connected to the calculation module, wherein when the fund-end host receives a transfer request comprising a source wallet address, a destination wallet address, and a transfer amount, the transfer module executes the subscription function and the redemption function of the smart contract, wherein when the subscription function is executed, M token corresponding to the transfer amount is generated and transferred to the destination wallet address, and the number of the M token and the destination wallet address are stored in the register of shareholders, and when redemption function is executed, the M token corresponding to the transfer amount is destroyed in the source wallet address, wherein M is a positive integer.

2. The creating and trading system for tokenized open-end fund according to claim 1, wherein the register of shareholders comprises at least one piece of shareholder metadata and a shareholder wallet address corresponding to the at least one piece of shareholder metadata, and when smart contract is executed, the smart contract is permitted to create, read, update or delete the shareholder metadata and the shareholder wallet address corresponding to the shareholder metadata.

3. The creating and trading system for tokenized open-end fund according to claim 2, wherein when the fund-end host receives a sell request from a seller's host and the purchase request of the buyer's host exists in the fund-end host, the fund-end host compares second price information of the sell request and the first price information of the purchase request, when the second price information matches the first price information, the fund-end host executes the subscription function and the redemption function, to destroy the token equivalent to the second price information in the wallet address of the buyer's host, transfer the token equivalent to the second price information from the fund wallet address to a wallet address of the seller's host, update the shareholder metadata and the shareholder wallet address corresponding to the buyer's host and the seller's host in the register of shareholders.

4. The creating and trading system for tokenized open-end fund according to claim 2, wherein when the fund-end host generates the token, the fund-end host stores the number of the generated token and transaction party information to the register of shareholders as one of the at least one piece of the shareholder metadata, and stores the wallet address of the buyer's host or the destination wallet address as the shareholder wallet address corresponding to the shareholder metadata, and transfers the generated token from the fund wallet address to the corresponding shareholder wallet address.

5. The creating and trading system for tokenized open-end fund according to claim 1, wherein the token is destroyed by transferring the token to an eater address or executing the destroy function of the smart contract to destroy the token.

6. A creating and trading method for tokenized open-end fund, applied on a blockchain network, comprising:
providing a fund-end host, wherein the fund-end host is permitted to connect and access the blockchain network;
deploying a smart contract and a fund wallet address corresponding to an open-end fund in the blockchain network, by the fund-end host, wherein the smart contract comprises a register of shareholders, a subscription function, and a redemption function;
calculating, by the fund-end host, a return-of-investment (ROI) of the open-end fund in a preset fixed period, and calculating a performance fee based on the ROI, and adjusting a token value based on the performance fee;
when the fund-end host receives a purchase request from a buyer's host, executing the subscription function of the smart contract to generate N token based on the token value and first price information of the purchase request, to transfer the N token to the wallet address of the buyer's host from the fund wallet address, and store the number of the N token and the wallet address of the buyer's host in the register of shareholders, wherein N is a positive integer; and
when the fund-end host receives a transfer request comprising a source wallet address, a destination wallet address and a transfer amount, executing the subscription function and the redemption function of the smart contract, wherein when the subscription function is executed, M token corresponding to the transfer amount is generated and transferred to the destination wallet address, the number of the M token and the destination wallet address are stored in the register of shareholders, and when the redemption function is executed, the M token is destroyed in the source wallet address, wherein M is a positive integer.

7. The creating and trading method for tokenized open-end fund according to claim 6, wherein the register of shareholders comprises at least one piece of shareholder metadata and a shareholder wallet address corresponding to the at least one piece of shareholder metadata, and when smart contract is executed, the smart contract is permitted to create, read, update or delete the shareholder metadata and the shareholder wallet address corresponding to the shareholder metadata.

8. The creating and trading method for tokenized open-end fund according to claim 7, further comprising:
when the fund-end host receives a sell request from a seller's host and the purchase request of the buyer's host exists in the fund-end host, comparing second price information of the sell request and the first price information of the purchase request;
when the second price information matches the first price information, executing the subscription function and the redemption function, to destroy the token equivalent to the second price information in the wallet address of the buyer's host, transfer the token equivalent to the second price information from the fund wallet address to a wallet address of the seller's host, and update the shareholder metadata and the shareholder wallet address corresponding to the buyer's host and the seller's host in the register of shareholders.

9. The creating and trading method for tokenized open-end fund according to claim 7, further comprising:
when the fund-end host generates the token, storing the number of the generated token and transaction party information to the register of shareholders as one of the at least one piece of the shareholder metadata, and storing the wallet address of the buyer's host or the destination wallet address as the shareholder wallet address corresponding to the shareholder metadata, and transferring the generated token from the fund wallet address to the corresponding shareholder wallet address.

10. The creating and trading method for tokenized open-end fund according to claim 6, wherein the token is destroyed by transferring the token to an eater address or executing the destroy function of the smart contract to destroy the token.
